(19) United States
(12) Patent Application Publication
(10) Pub. No.: US 2026/0254162 A1
(43) Pub. Date: Aug. 27, 2026

(54) ELECTRICAL CONNECTION CONNECTOR WITH ASYMMETRICAL FASTENING CONTACT MODULES AND ASSOCIATED LOCKING DEVICE

(71) Applicant: Amphenol Air LB, CARIGNAN (FR)

(72) Inventors: Thomas VALTIER, THIS (FR); Christian CAVAILLES, GUJAN-MESTRAS (FR)

(73) Assignee: Amphenol Air LB, CARIGNAN (FR)

(21) Appl. No.: 19/546,991

(22) Filed: Feb. 23, 2026

(30) Foreign Application Priority Data
Feb. 21, 2025 (FR) 2501804

(51) Int. Cl. H01R 13/627; H01R 12/72; H01R 43/26

(52) U.S. Cl. CPC H01R 13/6273; H01R 12/724; H01R 43/26

(57) ABSTRACT

The present invention relates to a contact module for an electrical connection connector, comprising a casing delimiting a housing configured to receive at least one contact element overmoulded in a support, said contact element comprising a first end intended to cooperate with a contact element of an adjacent complementary module, and a second end in the form of a curved contact strip intended to support a printed circuit, fastening means comprising a first and a second snap-fit tabs, each snap-fit tab comprising at least one protruding and inclined bearing surface relative to the longitudinal plane of the casing, the first snap-fit tab is located on a first longitudinal face of the casing and the second snap-fit tab, separate from said first snap-fit tab, is located on an opposite longitudinal face of said casing.

### CROSS-REFERENCE TO RELATED APPLICATION

This application claims the benefit of French Application No. FR2501804, filed Feb. 21, 2025, the entire disclosure of which is hereby incorporated by reference.

### TECHNICAL FIELD

The present invention relates to a contact module intended for an electrical connection connector.

More particularly, the invention is applicable to modular type connectors used in environments requiring a compact assembly and increased mechanical strength, particularly in the fields of aeronautics, railways and industrial applications.

### BACKGROUND

In electrical connection connectors used in aeronautical or industrial applications, it is common to use contact modules that can be inserted into a connector casing.

These contact modules generally comprise electrical contacts overmoulded in an insulating support and are held in position by means of snap-fit tabs cooperating with complementary recesses provided in the casing.

Modular connectors are widely used for interconnecting various electrical and electronic equipment. They integrate several contact modules assembled side by side in a common housing, each module being provided with fastening means allowing it to be held in the connector.

In existing solutions, contact modules are fastened by snap-fit tabs inserted into complementary recesses of the connector.

However, these configurations have several limitations.

Firstly, mechanical interference occurs between the snap-fit tabs, which makes insertion and removal of contact modules difficult.

Secondly, the bearing surfaces of snap-fit tabs reduce the mechanical strength of the module in the connector, thus affecting retention force and stability of the assembly.

Furthermore, the arrangement of snap-fit tabs in existing solutions limits the maximum deployment of bearing surfaces, thus restricting locking effectiveness and increasing the risk of accidental disengagement of contact modules.

Hence, these limitations may compromise holding reliability of modules in the connector and require improvements aimed at optimising retention of modules while guaranteeing their extraction during disassembly.

### SUMMARY

The present invention relates to a contact module for an electrical connection connector, comprising a casing delimiting a housing configured to receive at least one contact plate overmoulded in a support, said contact plate comprising a first end intended to cooperate with a contact element of an adjacent complementary module, and a second end in the form of a curved contact strip intended to support a printed circuit, said casing comprising a first and a second snap-fit tabs, each snap-fit tab comprising at least one protruding and inclined bearing surface relative to the longitudinal plane of the casing.

Advantageously, the first snap-fit tab is located on a first longitudinal face of the casing and the second snap-fit tab, separate from said first snap-fit tab, is located on an opposite longitudinal face of said casing.

The invention thus aims to improve the fastening of contact modules of an electrical connection connector by removing mechanical interferences between adjacent modules and by increasing the bearing surface of the snap-fit tabs.

Furthermore, the first snap-fit tab comprises a single bearing surface and the second snap-fit tab comprises a double bearing surface.

In addition, the bearing surfaces of the tabs are positioned on separate planes perpendicular to the horizontal axis of the casing

Moreover, the snap-fit tabs are one-piece with the casing and produced by moulding.

Another object of the invention relates to an electrical connection connector, comprising at least two contact modules as defined above, assembled adjacently and aligned along a longitudinal axis, at least one inner wall located between two adjacent modules, said inner wall comprising complementary recesses configured to receive the bearing surfaces of the snap-fit tabs of the contact modules, the bearing surfaces of the snap-fit tabs being positioned on separate planes perpendicular to the horizontal axis of the connector and configured to be inserted into said complementary recesses aligned with said separate planes.

Additionally, the contact surfaces of the snap-fit tabs are arranged in a staggered manner on separate planes in the transverse direction.

Finally, the invention relates to an unlocking tool for an electrical connection connector as defined above, comprising a handle, a body connected to said handle, said body comprising asymmetrical ends, each end being adapted to cooperate with opposite bearing with the snap-fit tabs.

Advantageously, the first end is configured to cooperate with the snap-fit tab with a double bearing surface, and the second end is adapted to cooperate with the snap-fit tab with a single bearing surface.

### DESCRIPTION OF THE DRAWINGS

Other aims, features and advantages of the invention will become apparent upon reading the following description, given solely by way of non-limiting example and with reference to the appended drawings wherein:

FIG. 1 is a perspective view of a connector according to the invention.

FIG. 2 is a perspective view of a contact module mounted in the connector of FIG. 1;

FIG. 3 shows a sectional view of the staggered arrangement of a contact module in a connector;

FIG. 4 shows a detail of the staggered arrangement of the bearing surfaces of the tabs in the recesses of the connector; and

FIG. 5 shows an unlocking tool according to the invention.

### DETAILED DESCRIPTION

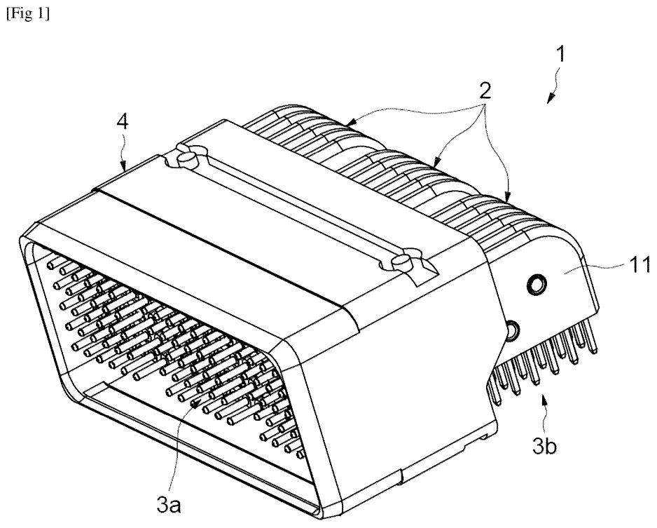

FIG. 1 shows the general structure of an electrical connection connector, denoted by the general reference number 1.

The connector 1 comprises a set of contact modules, in particular male contact modules 2 and female contact modules (not shown).

Each male contact module 2 is intended to cooperate with a complementary female contact module.

The female contact module comprises, generally, contact bushings each intended to receive a male contact element 3 of the corresponding male contact module 2.

Female contact modules are known and will not be described further in the remainder of the description.

In the remainder of the description, the term “contact module” will therefore be understood to mean “male contact module”.

In the example illustrated, the connector 1 comprises a base 4 provided with three parallel reception zones 5 each intended to receive a contact module 2.

These reception zones 5 integrate inner walls 6, each being disposed between two adjacent contact modules 2 and comprising complementary recesses 7, which will be described hereinafter.

By way of non-limiting example, the number of contact modules 2 is three here, and they thus constitute a strip of contact modules 2.

Generally, such an assembly is intended to be mounted in a connector 1 as illustrated in FIG. 1, for example for use on board an aircraft.

Such a configuration of the electrical connection connector 1 allows optimised holding of the contact modules 2 and ensures a precise alignment of the contact modules in the connector 1, making it possible, inter alia, to reduce mechanical vibrations.

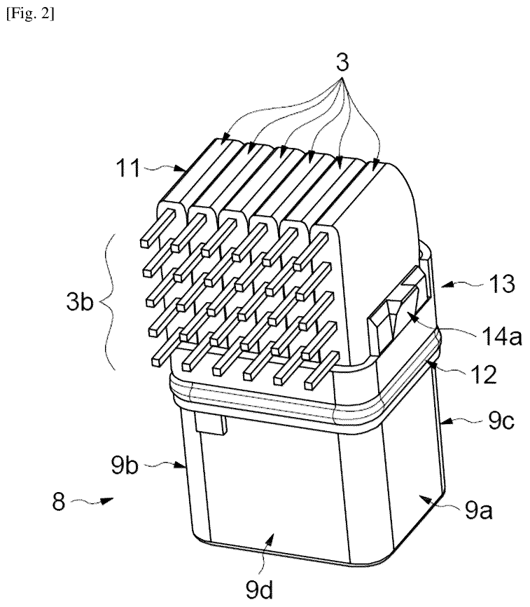

Hereinafter, the structure of each contact module 2 will be explained in detail with reference to FIGS. 2 to 4.

FIG. 2 shows a perspective view of a contact module 2 mounted in the connector 1 of FIG. 1.

Each contact module 2 comprises an insulating casing 8 of general parallelepiped shape comprising two longitudinal faces 9a, 9b, generally planar, a first transverse face or front face 9c, and a second transverse face or back face 9d.

The casing 8 is usually made of rigid plastic material and internally delimits a housing 10 receiving a plurality of contact plates 3 overmoulded in a support 11.

In the exemplary embodiment illustrated, the number of contact plates 3 is six per contact module 2.

Alternatively, a number of contact plates 3 greater than or equal to one per contact module 2 could be provided.

Each contact plate 3 generally comprises a first end 3a intended to cooperate with an adjacent complementary contact element, and a second end 3b in the form of a curved contact strip allowing a connection, for example with a printed circuit (not referenced).

The curved contact strip of the second end 3b of the contact plate 3 may define a predefined angle, for example 90°, or any other value allowing an effective connection with a printed circuit.

Each contact module 2 further comprises a sealing element 12 made of a relatively flexible plastic material, for example silicone, which can be directly overmoulded onto the casing 8.

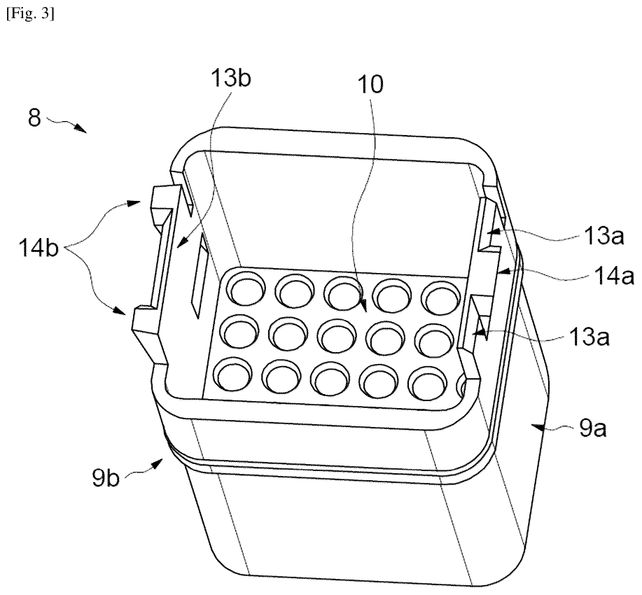

To explain the structural elements of the casing 8 of a contact module 2 in more detail, it is shown alone in FIG. 3.

As described above, an insulating casing 8 of a contact module 2 has two opposite longitudinal faces 9a, 9b.

The opposite longitudinal faces 9a, 9b of the insulating casing 8 are each provided with fastening means protruding from the base of the casing.

More particularly, the fastening means of a contact module 2 comprise at least two snap-fit tabs 13a, 13b, each comprising a bearing surface 14a, 14b.

Each snap-fit tab 13a, 13b consists of a protruding elongated structure relative to the longitudinal plane of the casing 8.

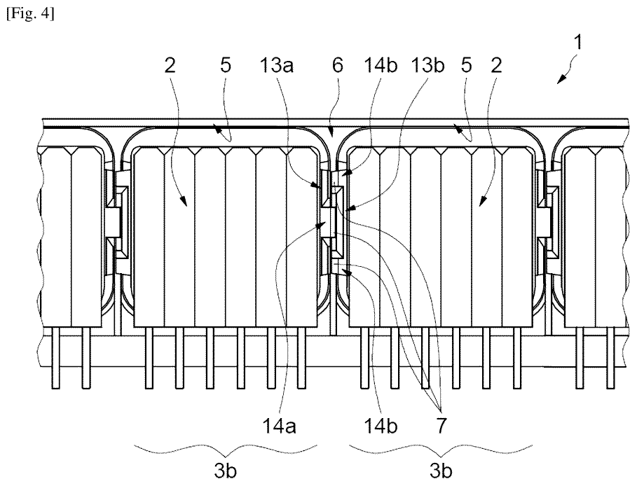

Each snap-fit tab 13a, 13b comprises at least one inclined bearing surface 14a, 14b, configured to be inserted into and bear against a complementary recess 7 of an inner wall 6 of the connector and ensure the locking of the contact module 2 once mounted. This will be described in more detail in FIG. 4.

The inclination of the bearing surfaces 14a, 14b makes it possible to improve the distribution of the fastening forces and can facilitate insertion and removal of the contact module 2 in the connector 1 at the time of mounting.

Advantageously, the snap-fit tabs 14a,14b are one-piece with the insulating casing 8 and produced by moulding.

In addition to facilitating production, this particularly makes it possible to reduce any risk of deformation or rupture of the snap-fit tabs 13a, 13b during mounting or withdrawal in a connector 1.

Furthermore, unlike known solutions, it can be seen in the example illustrated in FIG. 3 that the snap-fit tabs 13a, 13b of the casing 8 of the contact module 2 have a functional asymmetry.

Thus, the first snap-fit tab 13a is located on a first longitudinal face 9a of the casing 8 and comprises a single surface 14a.

The second snap-fit tab 13b, separate from the first tab 13a, is located on an opposite longitudinal face 9b and comprises a double bearing surface 14b.

The alternating arrangement of the snap-fit tabs 13a, 13b on opposite longitudinal faces 9a, 9b prevents mechanical interference between adjacent modules 2, thus ensuring more precise engagement and additionally reducing premature wear of the bearing surfaces 14a, 14b.

Moreover, such an asymmetrical arrangement also makes it possible to increase the bearing surface of the snap-fit tabs 13a, 13b in the connector after mounting and hence improve retention of the contact modules 2 in the connector 1.

FIG. 4 shows a sectional view of two contact modules 2 mounted side by side in reception zones 5 of the connector 1 in a configuration shown in FIG. 1.

The connector 1 is designed to be compatible with conventional contact modules and contact modules 2 according to the invention, so as to allow interchangeability without modifying the connector 1.

This compatibility is particularly enabled thanks to the standardised inner walls 6 of the reception zones 5 of the connector 1.

The connector 1 may comprise one or more inner walls 6, each inner wall 6 separating two adjacent modules 2. Only one inner wall 6 is shown in FIG. 4.

Such an inner wall 6 comprises complementary recesses 7, which are configured to receive the bearing surfaces 14a, 14b of the snap-fit tabs 13a, 13b of the contact modules 2a, 2b.

These inner walls 6 anchor the snap-fit tabs 13a, 13b in the additional recesses 7 and ensure improved fastening of the contact modules 2 in the connector 1.

The recesses 7 of the inner walls 6 are arranged on separate planes perpendicular to the horizontal axis of the connector 1, which makes it possible to accommodate contact modules 2 of which the bearing surfaces 14a, 14b of the snap-fit tabs 13a, 13b are located at different heights.

The asymmetrical structure of the casings 8 then allows an alternating arrangement of adjacent contact modules 2 reducing risks of mechanical interference.

In FIG. 4, it can be seen that the snap-fit tabs 13a, 13b of adjacent contact modules 2 are indeed arranged in a staggered manner, with bearing surfaces 14a, 14b transversely offset and positioned on separate planes.

The staggered arrangement of the contact modules 2, illustrated in FIG. 4, directly contributes to improving mechanical retention of the contact modules 2 and to increasing their holding power.

By positioning the bearing surfaces 14a, 14b of the snap-fit tabs 13a, 13b on separate and transversely offset planes, this arrangement makes it possible to distribute fastening forces uniformly on the inner wall 6 of the connector 1.

This balanced distribution reduces localised stress on the casing 8 of the contact module 2, thus minimising risks of deformation upon repeated mechanical strains.

In addition, the staggered arrangement increases the effective bearing surface of the snap-fit tabs 13a, 13b, each tab 13a, 13b benefiting from optimal contact with the complementary recesses 7 of the connector 1, which considerably improves retention of the contact module 2 in the connector 1.

This increase in the bearing surface helps to better distribute pull-out strengths and limits axial movements of the contact modules 2, even in the presence of vibrations or shocks.

Eliminating direct interactions between snap-fit tabs 13a,13b of adjacent contact modules 2 also reduces the mechanical pressure exerted on each of them, thus guaranteeing robust and long-lasting fastening, while increasing resistance to wear and to external mechanical strains.

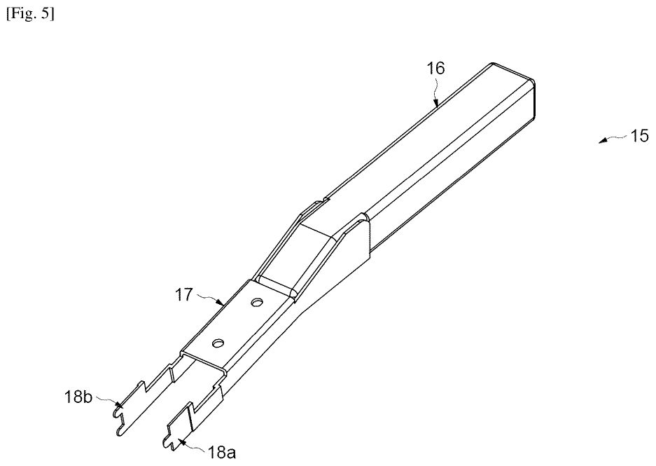

FIG. 5 now illustrates an unlocking tool 15 designed to cooperate effectively the casings 8 of the contact modules 2 and to allow disassembly of the contact modules 2 without excessive strain.

The unlocking tool 15 is intended to facilitate extraction of contact modules 2 mounted in the electrical connection connector, taking into account the asymmetrical arrangement of the snap-fit tabs 13a,13b.

The unlocking tool 15 comprises a handle 16 and a body 17 having at its end asymmetrical arms 18a, 18b, designed to cooperate with the complementary snap-fit tabs 13a, 13b of the contact modules 2.

For this purpose, the two separate arms 18a, 18b of the unlocking tool make it possible particularly to exert an unlocking force in a complementary and opposite manner on the snap-fit tabs 13a, 13b.

The arm 18a has a structure comprising a single contact point, making it possible to engage the two bearing surfaces 14b of the snap-fit tab 13b simultaneously, by exerting a force distributed on the two bearing points 14b for gradual unlocking.

The arm 18b has a structure adapted to the snap-fit tab 13a, comprising a single bearing surface 14a.

The arm 18b then applies a force distributed on two contact points, allowing a targeted unlocking without exerting excessive pressure on the snap-fit tab 13a.

This reverse bearing action of the unlocking tool 15 ensures that the unlocking forces are distributed symmetrically, thus avoiding excessive strain on the module casing.

The asymmetry of the arms 18a, 18b of the unlocking tool 15 allows a user to apply a differentiated force on each snap-fit tab 13a, 13b, thus reducing the risk of damaging the contact module 2 while facilitating its extraction from the connector 1.

Moreover, the handle 16 of the unlocking tool 15 may, by way of non-limiting example, be composed of a thermoplastic material, and the body 17 of the unlocking tool 15 may be composed, for example, of a metal material.

Thus, the tool 15 makes it possible to ensure quick and safe disassembly of the contact modules 2, without a risk of damaging the recesses 7 of the connector 1 and the snap-fit tabs 13a, 13b.

1. A contact module for an electrical connection connector, comprising:
a casing delimiting a housing configured to receive at least one contact plate overmoulded in a support,
said contact plate comprising a first end intended to cooperate with a contact element of an adjacent complementary module, and a second end in the form of a curved contact strip intended to support a printed circuit board,
said casing comprising a first and a second snap-fit tabs, each snap-fit tab having at least one protruding and inclined bearing surface relative to a longitudinal face of the casing,
characterised in that:
the first snap-fit tab is located on a first longitudinal face of the casing and the second snap-fit tab, separate from said first snap-fit tab, is located on an opposite longitudinal face of said casing,
and in that the bearing surfaces of the snap-fit tabs are arranged in a staggered manner on separate planes positioned at different heights in the inner wall.

2. The module according to claim 1, wherein the first snap-fit tab comprises a single bearing surface and the second snap-fit tab comprises a double bearing surface.

3. The module according to claim 1, wherein the bearing surfaces of the snap-fit tabs are positioned on separate planes.

4. The module according to claim 1, wherein the snap-fit tabs are one-piece with the casing and produced by moulding.

5. An electrical connection connector, comprising:
at least two contact modules according to claim 2, assembled adjacently,
at least one inner wall located between two adjacent modules, said inner wall comprising complementary recesses configured to receive the bearing surfaces of the snap-fit tabs of the contact modules,
the bearing surfaces of the snap-fit tabs are positioned on separate planes, said planes being aligned with complementary recesses arranged in the inner wall, and said bearing surfaces being configured to be inserted into said complementary recesses.

6. An unlocking tool for the electrical connection connector according to claim 5, comprising:
a handle,
a body connected to said handle, said body comprising asymmetrical ends, each end being adapted to cooperate with opposite bearing with the snap-fit tabs,
characterised in that:
the first end is configured to cooperate with the snap-fit tab with a double bearing surface, and the second end is adapted to cooperate with the snap-fit tab with a single bearing surface.
